(19) United States
(12) Patent Application Publication
(10) Pub. No.: US 2004/0069849 A1
(43) Pub. Date: Apr. 15, 2004

(54) System and method for handling packages

(75) Inventors: John Stevens, Toronto (CA); Paul Waterhouse, Toronto (CA); Mike Vandenberg, Toronto (CA)

Correspondence Address: McGinn & Gibb, PLLC, Suite 200, 8321 Old Courthouse Road, Vienna, VA, 22182-3817, US

(73) Assignee: eBox Inc., Toronto (CA)

(21) Appl. No.: 10/425,990

(22) Filed: Apr. 30, 2003

Related U.S. Application Data
(60) Provisional application No. 60/376,230, filed on Apr. 30, 2002.

(51) Int. Cl. G06F 17/60

(52) U.S. Cl. 235/385

(57) ABSTRACT

A system for handling packages includes an electronic module associated with at least one package, the electronic module including a memory device for storing handling data for the at least one package, a first transceiver, and a signaling device operatively coupled to the first transceiver. The system further includes at least one control station including a second transceiver for wirelessly communicating with the first transceiver to direct the handling of the at least one package.

### CROSS REFERENCE TO RELATED APPLICATIONS

This Application claims priority from U.S. Provisional Application No. 60/376,230 entitled “SYSTEM AND METHOD FOR SORTING AND SHIPPING PACKAGES”, which was filed on Apr. 30, 2002, and is incorporated herein by reference. This Application is related to International Application No. PCT/US02/10927 entitled “TOTE-BASED WAREHOUSING SYSTEM AND METHOD”, which was filed on Apr. 9, 2002, and is incorporated herein by reference.

### BACKGROUND OF THE INVENTION

1. Field of the Invention

The present invention generally relates to a system and method for handling (e.g., sorting and/or shipping) packages and, more particularly, to a system and method for handling packages which utilize an electronic module.

2. Description of the Related Art

Conventional package handling (e.g., sorting and shipping) systems and methods often rely heavily on bar codes and bar code scanners. For instance, a sender may take a package to be delivered to a courier service. The courier service may then enter delivery information (e.g., destination, date and time that delivery was initiated, etc.) into a system to generate a bar code which contains the encoded information. The bar code is then affixed to the package.

The courier service may then utilize a system of bar code scanners in order, to sort and ship the package to the desired destination. For instance, the courier may have a warehouse at the shipping point where each of the packages are scanned and placed in bins which contain packages for particular destinations.

However, such conventional systems are slow and costly. For instance, “pickers” who are sorting the packages at the warehouse must first locate the bar code on the package. The picker also will likely have to properly orient the package in order for the scanner to scan the bar code. In addition, the picker may have to make several attempts at scanning the information from the bar code into the scanner, which can be frustrating and time consuming.

Further, the package may leave the courier's shipping point and arrive at one or more distribution centers before being delivered to the final destination. Thus, the bar codes have to be scanned at each distribution center so that more pickers can again sort through the packages for shipment. Again, the pickers must locate the bar codes, properly orient the package and scan the package several times in order to put the packages in the correct bin for delivery.

Finally, when a package arrives at its final destination, the bar code on the package has to be scanned again, in order to document that the package has arrived at its destination. Thus, the delivery person must find the bar code and scan it several times in order to input the information into the scanner.

As a result of these inefficiencies, such conventional systems and methods for handling packages are labor intensive, time consuming and costly. Therefore, these inefficiencies in conventional systems of handling packages result in higher costs and longer shipping times.

### SUMMARY OF THE INVENTION

In view of the foregoing and other problems, drawbacks, arid disadvantages of the conventional systems and methods, a purpose of the present invention is to provide a cost efficient and time efficient system and method for handling (e.g., sorting and/or shipping) packages which minimizes time and labor required for handling the packages.

In a first aspect of the present invention, a system for handling (e.g., sorting and/or shipping) packages includes an electronic module associated with at least one package. The module includes a memory device for storing handling data (e.g., sorting and/or shipping data for the at least one package a first transceiver (e.g., radio transmitter/receiver), and a signaling device (e.g., light emitting diode (LED)) which may be operatively coupled to the first transceiver. The system also includes at least one control station having a second transceiver for wirelessly communicating with the first transceiver to direct the handling for the package. The system may also include a central controller for coordinating an operation of the control stations.

The electronic module may be removably attached to the package. Alternatively the system may also include a shipping container for storing the package, in which case the electronic module may be removably attached to the container. Alternatively, the electronic module may integrated into the shipping container.

More specifically, the module may include, for example, a radio frequency identification device (RFID). The control station may transmit a signal to the transceiver in the electronic module. For example, this signal may cause the electronic module on a package to activate the signaling device (e.g., an LED). An operator (e.g., picker) may detect that the signaling device is activated and handle (e.g., sort and/or ship) the package accordingly.

The present invention also includes an inventive method for handling (e.g., sorting and shipping) packages. The inventive method includes using an electronic module to store handling data pertaining to at least one package, and wirelessly communicating with the electronic module in order to direct the handling of the at least one package. The inventive method may also include placing the at least one package in a shipping container, which case the electronic module may be affixed to the shipping container.

The present invention also includes a signal-bearing media tangibly embodying a program of machine-readable instructions executable by a digital data processor to perform the inventive method for handling packages.

With its unique and novel features, the present invention offers affordable, state-of-the-art technology for managing and improving package handling (e.g., sorting and/or shipping) operations. This allows the invention to minimize the time and labor required to handle packages. The inventive system and method may also be conveniently offered as an independent or integrated solution to package handling needs.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 is a schematic drawing illustrating an inventive system for handling packages 100;

FIG. 2A illustrates a package 110 having an electronic module removably affixed thereto;

FIG. 2B provides a detailed illustration of the electronic module which may be associated with at least one package in the inventive system 100;

FIG. 3A illustrates a shipping container 310 for storing packages to be shipped and having an electronic module removably affixed thereto;

FIG. 3B provides a detailed illustration of the electronic module which mav be associated with at least one package and affixed to the shipping container 310 in the inventive system 100;

FIGS. 4A-4B are schematic drawings illustrating a layout of an inventive system 100 for handling packages according to the present invention;

FIG. 5 illustrates another aspect of the inventive system 500 which includes a central controller 510, according to the present invention;

FIG. 6 is a flow chart illustrating an inventive method for handling packages 500 according to the present invention;

FIG. 7 illustrates a typical information handling system configuration which may be used for implementing the system and method according to the present invention; and

FIG. 8 illustrates an example of a signal-bearing media which may be used to store a program for performing the method according to the present invention.

### DETAILED DESCRIPTION OF EXEMPLARY EMBODIMENTS OF THE INVENTION

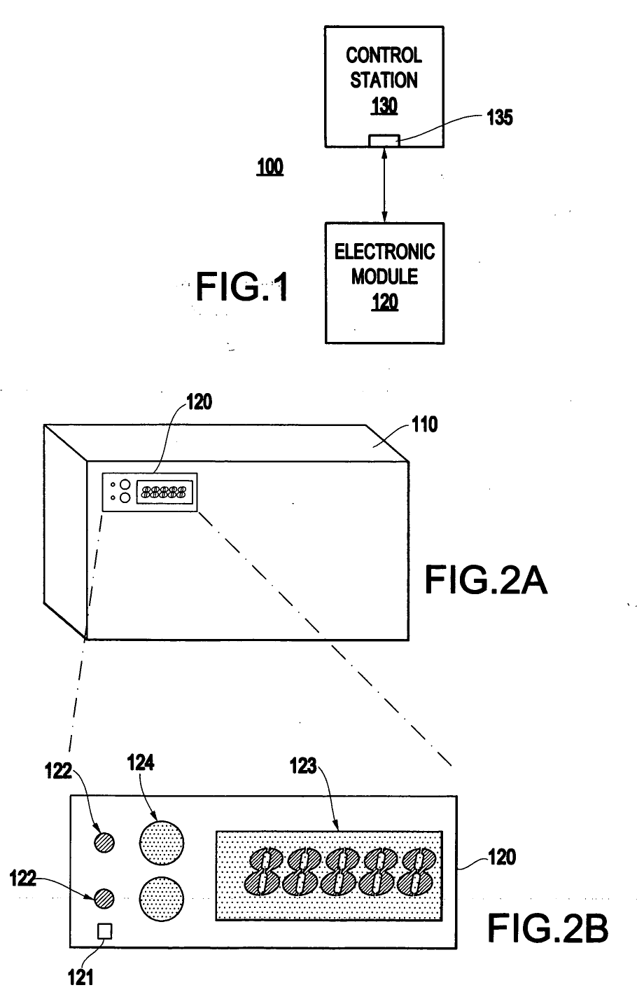

Referring now to the drawings, and more particularly to FIGS. 1-11, there are shown exemplary embodiments of the system and method according to the present invention.

As shown in FIG. 1, the present invention includes a system 100 for handling (e.g., sorting and/or shipping) packages. The inventive system 100 includes an electronic module 120 associated with at least one package, and at least one control station 130, each control station including a transceiver 135 for wirelessly communicating with the electronic module 120 to direct a handling operation (e.g., sorting operation and/or a shipping operation).

More specifically, the electronic module 120 includes a memory device for storing handling data (e.g., sorting data and/or shipping data), a transceiver for wirelessly communicating with the control station 120, and a signaling device (e.g., a light emitting device (LED)) which may be operatively coupled to the transceiver and/or memory device.

In short, the inventive system 100 may use the wireless electronic module 120 for storing package identity information, and providing improved picking methods (e.g., using the signaling device) in order to more efficiently handle (e.g., sort and/or ship) packages.

For example, the electronic module 120 could be attached to the packaging (e.g., on the outside of a package) or integrated into the packaging which contains the item (e.g., package) to be delivered. The packaging could be traditional, such as Tyvek envelopes, cardboard envelopes or cardboard boxes, plastic polymer envelopes, and the like. If the module 120 is integrated, it could be integrated as part of the packaging (e.g, permanently incorporated into the packaging).

For instance, the packaging for shipping a package (e.g., goods) could be made of an injection molded box, which could be sealed and opened many times. The module electronics may be removably attached to allow the module 120 to be removed and re-attached to another package/container for another shipment. Alternatively, the module electronics may be integrated into the reusable shipping box itself.

The reusable shipping container may also include a pouch for inserting shipping documents, such as a waybill, or other like document. Relevant shipping data may be loaded into the module by the sender or the courier company with relevant shipping information. For example, the sender may enter the shipping information (e.g., sender's information, recipient's information, date, time, etc.) into a desktop computer (e.g., at a control station) having a wireless transmitter/receiver connected thereto. The transmitter/receiver may transmit a wireless signal containing this data to the module on the package to be shipped.

The delivery company may, therefore. use this information to identify the package. For instance, an employee may access the information in the module (e.g., harvest information from the module) by transmitting a wireless radio frequency signal to the package, or by pressing a button on the module itself. This may cause the module to display information on a display device (e.g., liquid crystal display (LCD)) or by blinking a LED (light emitting diode) on the module.

Therefore, several packages with programmed modules could be handled (e.g., sorted) very quickly, with far less time and labor required than in conventional systems. A wireless signal could also be transmitted to a bin of such module-based packages to identify packages going, for example, to a predetermined destination (e.g., Los Angeles). In this case only those packages that are to be shipped to Los Angles would blink their LED lights, thereby eliminating or reducing the need to read the paper waybill or bar-code scanning the waybill. As each package is sorted by destination by this system and method, the delivery personnel could also re-verify the module's LED by bar-code scanning the package as it is transferred to the Los Angeles sorting bin.

Furthermore, the module-based shipping packages may also be randomly loaded onto an automated sorting conveyor for even faster sorting efficiencies. The conveyor may transport loose packages through a transmitter antenna which may wirelessly communicate with (e.g., query) the package as to identity and destination. For instance, if the module on the package is queried and responds and sends a wireless signal back, the package could then be redirected to another conveyor. In this way, packages could be rapidly separated and sorted by destination or delivery requirements (e.g., overnight/next day, 2-day delivery, air, ground) and sent into an appropriate bin or conveyor. In other words, the handling (e.g., sorting) process may be automated so that the package rarely has to be handled by pickers.

The module 120 may also be easily reprogrammed with new handling information (e.g., sort/delivery information) so that it may be used over and over again. Further, if a package is reusable as described above, the package may also be reused along with the attached or alternatively, integrated module.

Therefore, the inventive system 100 leads to highly efficient handling (e.g., sorting and/or shipping) of packages. The inventive system 100 is based in part on a wireless system that may use display modules and short range low frequency RF transmitted through loop antennas similar to those used for grocery store pricing modules.

In addition, as noted above, the electronic module 120 may be affixed (e.g., removably affixed) to the package to be delivered, or affixed to a shipping container which contains the package. For example, the shipping container used in the inventive system 100 may be formed of varying dimensions and may be used to store several packages.

For instance, the shipping container may have suitable dimensions (e.g., approximately 18″×18″ by 24″ in an exemplary non-limiting embodiment) and may be made from conventional materials (e.g., plastic). The shipping container may be smaller or larger, and a warehouse may use a plurality of shipping containers having a variety of sizes.

Further, an electronic module 10 (e.g., radio frequency identification module (RFID)) may be associated with at least one package (e.g., a plurality of packages) to be handled (e.g., sorted and/or shipped). For instance, the electronic module 110 may be affixed (e.g., removably) directly on a package or on a shipping container which contains at least one package. More specifically, the module 120 may be a wireless battery operated module capable of two-way communication.

As shown in FIG. 2A, an electronic module 120 may be directly affixed to the package 110 to be handled (e.g., sorted/delivered). Specifically, the electronic module 120 may include a memory device 121 (e.g., semiconductor memory; random access memory (RAM) for storing a unique identification (ID) number, two light emitting devices 122 (e.g., light emitting diodes (LEDs)) which may have different colors (e.g., red and green), a display device 123 (e.g., liquid crystal display (LCD)) which may include a five-digit display, and at least one device 124 (e.g., button) for activating/deactivating a feature of the module 120 (e.g., the LED, display device, etc.).

Of course, many variations of the module 120 configuration are possible. The module 120 may use a low power complementary metal oxide semiconductor (CMOS) circuitry and. with a standard lithium battery, will operate for a period of many years. The memory device 121 may also store button pushes or other parameters associated with the status of the tote (e.g., weight, temperature, etc.). The memory device 121 may also store identification numbers (e.g., UPC) corresponding to items of merchandise which are contained in the tote 110 or which are to be transferred to or from the tote 110.

The inventive system 100 also includes at least one control station 130 (e.g., a plurality of control stations) which wirelessly communicates with the module 120. Specifically, the controller 130 may communicate with the module 120 in order to direct a sorting operation and/or a shipping operation. For instance, several control stations 130 may be located along a conveyor in a sorting area, in order to quickly sort packages.

Specifically, the control station 130 may include a processor (e.g., microprocessor), memory device and two way radio device (e.g., transmitter/receiver). For instance. the control station 130 may include a computer system which is capable of directing a radio transmitting/receiving function. For instance, the controller 130 may wirelessly communicate with the module 120 using low frequency (e.g., 300 Ghz) two-way radio frequencies.

The inventive system 100 may also include an antenna (e.g., antennas) (not shown) to facilitate communication between the control station 130 and the module 120. The antenna may include one or more antenna loops (e.g., wire loops) and communication may be limited to the area within a loop. These antenna loops may be placed, for example, in the floor, behind a shelf or in the ceiling.

Thus, when a given loop is activated, it can poll for a specific module 120 and if the module 120 is present, it can be made to respond to the poll. In other words, the loops may be located along a conveyor belt in a sorting area and may “ping” the packages as the packages travel along the conveyor, in order to elicit a response from a module 120. Thus, the control station 130 (e.g., a software system operated by the control station 130) may direct a search for packages going to a particular location by polling the modules 120.

Thus. if a module 120 responds (e.g., if the software system establishes communication) the inventive system 100 may cause the module's display device 123 to display a particular number, read whether a particular button 124 has been pushed or not, activate or deactivate the LED 122 (e.g., red, green, etc.), read back the identification number of the module 120, read the contents of the memory device 121, etc.

Further, the control station 130 may poll the modules 120 in order to identify packages based on other criteria, not just a destination. For instance, the modules 120 may be polled to identify packages which are late or packages which have a particular term of delivery (e.g., overnight delivery). The modules 120 may also be polled in order to prevent unauthorized removal of the package from a distribution center.

Further, the conveyor system could be designed so that the information transmitted from the module on a package may be used to automatically alter the conveyor for that package. For example, if a package is going to Los Angeles, a conveyor guide may guide the package into a bin for packages to go to Los Angeles, but if the system 100 detects (e.g., from information transmitted from the electronic module) that the package is to go to New York, the conveyor may automatically reconfigure (e.g., a guide may be automatically moved) so that the package is re-directed into the New York bin.

Moreover, the control station 130 may poll the modules 120 in order to identify packages which have been received from a particular location. Thus, the inventive system 100 may be used as a security device, for example, to verify a “chain of possession” for a package. Thus, for example, the inventive system 100 may safeguard against the tampering with or diverting the package from the distribution chain and then re-entering the same.

Further, the control station 130 may be portable (e.g., handheld) so that it can be easily moved to a location near a package or shipping container (e.g., a package on a delivery truck or in a transport bin, or a very large package that is too large to place on a conveyor) to easily poll the module 120 on the package or shipping container.

Moreover, the control station 130 may include an input device (e.g., a keyboard) which may be used to program or re-program the electronic module on a package or shipping container. For instance, if a customer calls the courier desiring to change the package destination, the control station 130 may be used to locate the package in the warehouse by wirelessly communicating with the electronic module associated with the package. Once located, the input device on the control station may be used to enter the new shipping data, which is then transmitted to the electronic module on the package or shipping container.

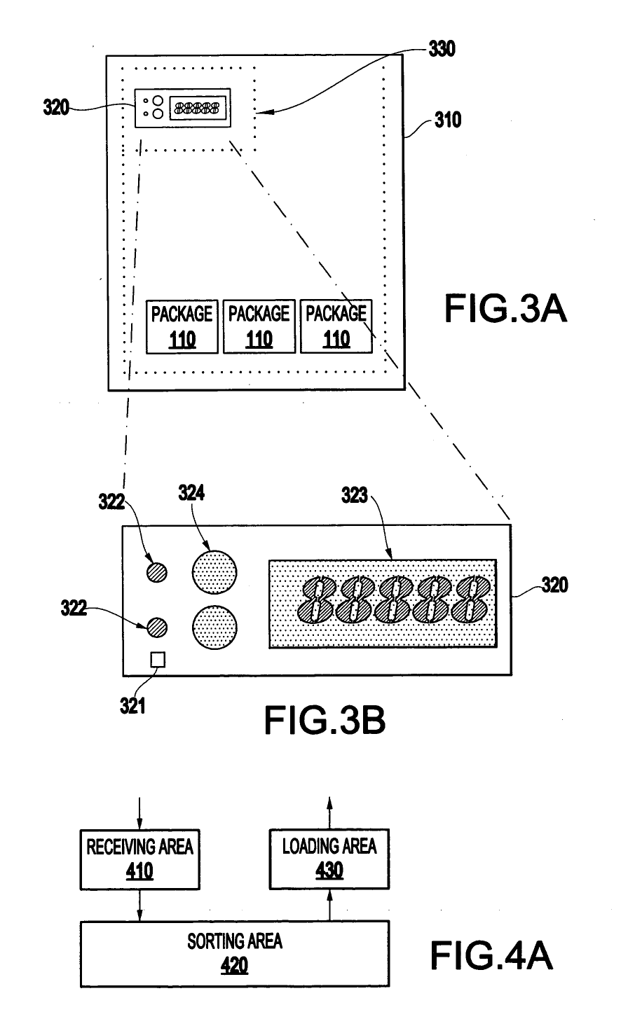

Referring again to the drawings, as shown in FIG. 3A, the package 110 may be placed in a shipping container 310 for delivery. As noted above, the shipping container 310 may be made of conventional materials, such as cardboard or plastic (e.g., polymeric material).

Further, as shown in FIG. 3B, the shipping container 310 may also be associated with an electronic module 320 similar to the module 120 discussed above. For instance, the module 320 may include a memory device 321 (e.g., semiconductor memory; random access memory (RAM) for storing a unique identification (ID) number, two light emitting devices 322 (e.g., light emitting diodes (LEDs)) which may have different colors (e.g., red and green), a display device 323 (e.g., liquid crystal display (LCD)) which may include a five-digit display, and at least one device 324 (e.g., button) for activating/deactivating a feature of the module 320 (e.g., the LED, display device, etc.).

Further, the module 320 maybe affixed to the shipping container 310. For instance, the shipping container 310 may include a pocket 330 on the front of the shipping container 310 for containing the module 320.

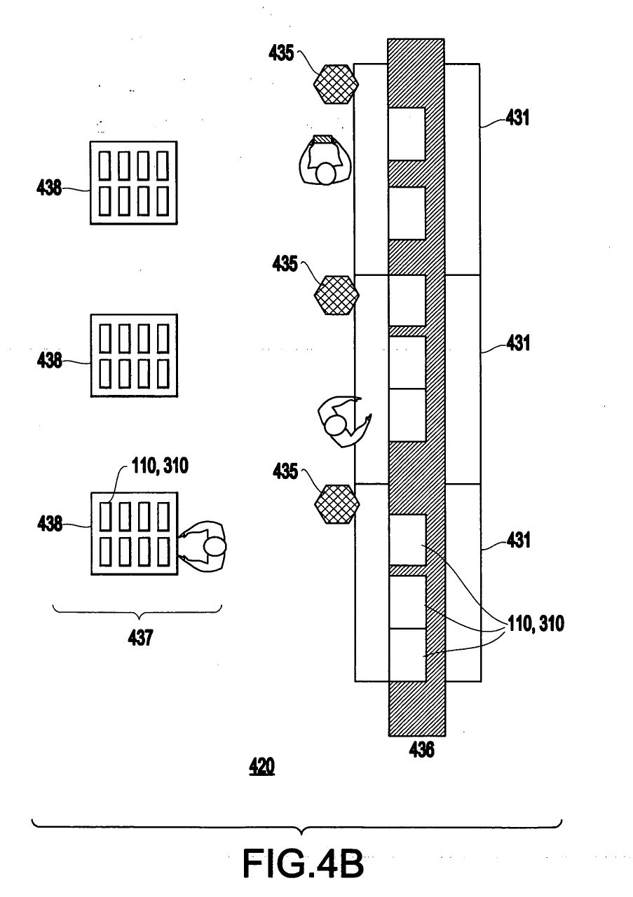

The inventive system 100 provides a fast and efficient tool for sorting and shipping packages and may be used in virtually any setting (e.g., distribution center, warehouse, etc.). For instance, FIGS. 4A and 4B illustrate examples of how the inventive system 100 for handling packages may be implemented according to the present invention.

As shown in FIG. 4A, packages may arrive at the facility (e.g., a warehouse) at the receiving area 410. At the receiving area 410, information pertaining to the package (e.g., destination, date and time delivery was initiated, terms of delivery, etc.) may be entered into the system 100. Specifically, the information may be entered into the control station 130 and wirelessly transmitted to and stored in the electronic module 120, which may then be associated with (e.g., affixed (e.g., removably affixed)) to the package. Alternatively, the package may be placed in a shipping container and an electronic module 320 programmed with information pertaining to the package associated with (e.g., affixed) to the shipping container.

The package 110 or shipping container 310 containing the package may then be transported to the sorting area 420. For example, the packages 110 and/or containers 310 may be transported to the sorting area 420 by a conveyor belt. The package may be also be transported by transport bin, hand delivery, or other device.

The sorting area 420 may include a control station 130 (not shown in FIG. 4A)(e.(J., a plurality of control stations) for directing the sorting operation and/or shipping operation. For example, several control stations 130 maybe located along the conveyor belt. Thus. the control stations 130 may use the transceiver therein to wirelessly communicate with the module which is associated with the package. As noted above, the module 120, 320 may respond to a communication (e.g., polling) from the control station 130 so that the associated package may be properly routed.

For instance, the module 120, 320 may cause the signaling device (e.g., LED) on the module to activate (e.g., light) so that a human picker may remove the associated package from the conveyor and place it on another conveyor or into a bin for further processing. Alternatively, an electronic detector may be used to identify packages that have responded to a polling by a control station 130 so that the package may be automatically (e.g., without any human interaction) removed from the sorting conveyor and placed on another conveyor or into a bin for further processing.

The package and/or shipping container may be transported from the sorting area 420 to the loading area 430 where the package and/or shipping container is loaded (e.g., onto a delivery truck) for delivery to a distribution center or to the destination. Specifically, the package and/or shipping container may be transported to the loading area 430 by another conveyor. Alternatively, the package or shipping container may be transported to the loading area 430 by a transport bin, hand delivery, or other device.

For example, a control station 130 located at a sorting area 420 may communicate with a module 120 on a package or shipping container to indicate that an associated package is to be delivered to a certain destination under certain terms (e.g., overnight, 2-day, etc.). For instance, the control station 130 may cause the module to activate an LED which can be seen by a human operator (e.g., picker) to indicate that the package is to be placed on a certain conveyor or bin for transport to the loading area 430. It should be noted that the module may include an audible signal (e.g., bell) instead of the LED as a signaling device.

The module responding to the control station 130 may be transferred (e.g., by an operator or automatically) from the sorting area 420 to the loading area 430. Here, the package may be transferred from a conveyor or transport bin onto a delivery truck, for example, for delivery to a distribution center or destination.

FIG. 4B provides a detailed illustration of a sorting area 420. As shown in FIG. 4B, the sorting area 420 may include a conveyor lane 436. The sorting area 420 may also include a transport bin staging area 437 where the packages that have been removed from the conveyor lane 436 (e.g., by human pickers or automatically using an electronic detector) are placed in transport bins 438. Alternatively, the packages may be directed (e.g., by human pickers or automatically using an electronic detector) from the conveyor lane 436 and placed on another conveyor.

For instance, as the package with an associated module moves to the sorting area 420, a signaling device (e.g., an LED) on the module may be turned off (e.g., deactivated). The package arrives at the sorting area 420 and goes past several picking regions 431 until it comes to the region that has a destination assigned to the package.

When that particular package reaches that region 431, a control station 130 (e.g., via software control) may cause the signaling device (e.g., red light) on the module 120 on that particular package to activate. The “picker” may see the light flashing and remove the package from the conveyor.

Further, the operator may scan the package removed from the conveyor using a scanner 435 provided in the sorting area 430. The control station 130 (e.g., software system) may detect that the package has been scanned and turns off the package's LED. The operator may transfer the package to the transport bin staging lane 437 where the package may be loaded into a transport bin 438. The control station 130 may (e.g., simultaneously with deactivating the package LED) activate an LED on a transport bin 438 that is supposed to receive the package. The picker may place the package in the transport bin 438 that is flashing. Alternatively, a control station 130 may cause the module associated with the package to activate another signaling device (e.g,. a green light) to indicate that the package has been placed in the proper transport bin or on the correct conveyor for conveyance to the loading area 430.

Thus, pickers may, for example, work within their region in the sorting area 420 and simply take packages having a red flashing light in the conveyor lane 436, scan it and place it in the transport bin 438 that has a flashing light in the transport bin staging area 437. A package which has not been removed from the conveyor lane 436 may simply stay on the conveyor belt to return to the picking regions 431.

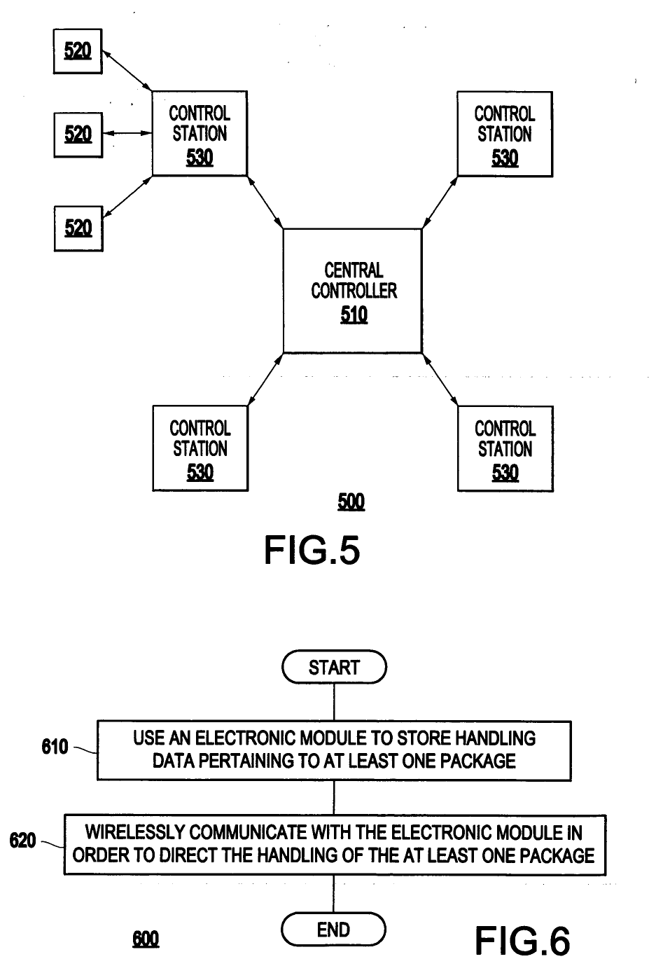

In another aspect, as shown in FIG. 5, the inventive system 500 may include a central controller 510 for coordinating an operation of the inventive system 500. For instance, the central controller 510 may include a computer system which a user may operate in order to program or re-program several control stations 530 throughout a warehouse.

For instance, using the central controller 510, the user may program a certain control station 530 to poll the modules 520 for location on one day, and poll for delivery date on another day. The user may likewise program the control station 530 to poll the modules for a certain location on one day, and for another location on another day.

In short, unlike conventional systems, the inventive system 100, 500 provides optimized high throughput for handling (e.g., sorting and/or shipping) packages without relying extensively on human pickers/sorters. The inventive system 100, 500 relies in part on the electronic module 120, 520 associated with a package. However, unlike many radio frequency (RF) tag devices in conventional systems the module 120, 520 may include: two LEDs, an 8 Digit LCD, three operating switches (e.g., activating/deactivating buttons), a two way 300 Khz 1200 baud RF link. programmable functionality, and a preprogrammed unique identification (e.g., ID number). Further, each module 120, 520 may be used to a destination. delivery due date, etc., in addition to displaying all other warehouse functions on demand for pickers, including pick-to-light LEDs.

Referring again to FIG. 1, the control station 130 wirelessly communicates with the module (e.g., RFID module) 120, in order to identify and locate packages to be handled (e.g., sorted). It should be noted that FIG. 1 is merely illustrative and that the control station 130 may include a plurality of control stations. Likewise, the RFID module may be located either on the package or on a shipping container containing the package.

In addition, inventive system 100, 500 is very flexible. Its installation can be configured to as low as 2,000 modules, yet there is no practical limit on the size of facility or number of SKUs. The inventive system 100, 500 further provides a wireless, real-time package handling (e.g., sorting and shipping) system which may use pick-to-light (PTL) and RFID technology, and which may be coupled with a proprietary software. The control station(s) 130, 530 allow for the handling (e.g., sorting and shipping) of packages without the burdensome requirement of printing bar code labels and attaching the label to the package, and locating and scanning the bar code labels.

Further, the proprietary wireless display module 120, 520 is designed so as to allow the control station(s) 130, 530 to selectively “talk” to the module 120, 520 when it is located anywhere in or around the warehouse facility. In addition, the modules 120, 520 can be attached to any package or shipping container. Once an SKU is identified to the module 120, 520, a package may be placed anywhere in or around the facility and the control station(s) 130, 530 will “locate” it.

Further, the inventive system 100, 500 is configurable to any warehouse operation. Its basic functionality may include, for example receiving, dynamic picking, packing, shipping, cross docking, RF communications for all functions, report generation, order management, wave management, weight check, cycle counting, etc.

The inventive system 100, 500 may be incorporated at distribution centers as well as at the package receiving location (e.g., the location for receiving the package from the sender). For example, a package shipped from New York City destined for Santa Monica, may first arrive at a distribution center in Los Angeles. Thus, the Los Angeles distribution center may utilize the inventive system 100, 500 to sort and ship packages in order to efficiently route the package to its destination in Santa Monica.

Referring to FIG. 6, the present invention also includes an inventive method 600 for handling (e.g., sorting and shipping) packages. As shown in FIG. 6, the inventive method includes using (610) an electronic module to store handling data pertaining to at least one package, and wirelessly communicating (620) with the electronic module in order to direct the handling of the at least one package. The inventive method may also include placing the at least one package in a shipping container, in which case, the electronic module may be affixed to the shipping container.

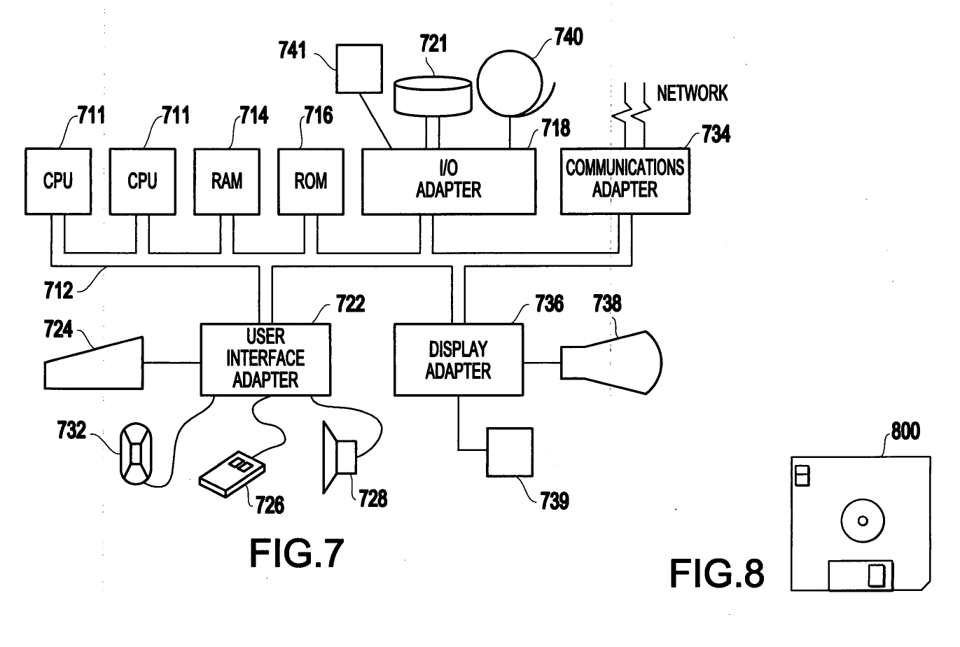

Referring again to the drawings, FIG. 7, illustrates a typical hardware configuration which may be used for implementing the inventive system 100 and method 500. The configuration has preferably at least one processor or central processing unit (CPU) 711. The CPUs 711 are interconnected via a system bus 712 to a random access memory (RAM) 714, read-only memory (ROM) 716, input/output (I/O) adapter 718 (for connecting peripheral devices such as disk units 721 and tape drives 740 to the bus 712), user interface adapter 722 (for connecting a keyboard 724, mouse 726, speaker 728, microphone 732, and/or other user interface device to the bus 1012), a communication adapter 1034 for connecting an information handling system to a data processing network, the Internet, and Intranet, a personal area network (PAN), etc., and a display adapter 736 for connecting the bus 712 to a display device 738 and/or printer 739. Further, an automated reader/scanner 741 may be included. Such readers/scanners are commercially available from many sources.

In addition to the system described above, a different aspect of the invention includes a computer-implemented method for performing the above method. As an example, this method may be implemented in the particular environment discussed above. Such a method may be implemented, for example, by operating a computer, as embodied by a digital data processing apparatus, to execute a sequence of machine-readable instructions. These instructions may reside in various types of signal-bearing media. Thus, this aspect of the present invention is directed to a programmed product including signal-bearing media tangibly embodying a program of machine-readable instructions executable by a digital data processor to perform the above method.

Such a method may be implemented, for example, by operating the CPU 711 to execute a sequence of machine-readable instructions. These instructions may reside in various types of signal bearing media.

Thus, this aspect of the present invention is directed to a programmed product, comprising signal-bearing media tangibly embodying a program of machine-readable instructions executable by a digital data processor incorporating the CPU 711 and hardware above, to perform the method of the invention.

This signal-bearing media may include, for example, a RAM contained within the CPU 711, as represented by the fast-access storage for example. Alternatively, the instructions may be contained in another signal-bearing media, such as a magnetic data storage diskette 800 (FIG. 8), directly or indirectly accessible by the CPU 711.

Whether contained in the computer server/CPU 711, or elsewhere, the instructions may be stored on a variety of machine-readable data storage media, such as DASD storage (e.g, a conventional “hard drive” or a RAID array), magnetic tape, electronic read-only memory (e.g., ROM. EPROM, or EEPROM), an optical storage device (e.g., CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, complied from a language such as “C,” etc.

With its unique and novel features, the present invention offers affordable, state-of-the-art technology for managing and improving package handling (e.g., sorting and/or shipping) operations. This allows the invention to minimize the time and labor required to handle packages. The inventive system and method may also be conveniently offered as an independent or integrated solution to package handling needs.

While the invention has been described in terms of several preferred embodiments, those skilled in the art will recognize that the invention can be practiced with modification within the spirit and scope of the appended claims. For example, while a scenario has been discussed with various colored lights, obviously different colored lights could be used, as well as different formats for the lights (e.g., pulsing, flashing, sequences of lights, etc.). Further, the lights may be caused to activate in a certain fashion to distinguish from other packages. For example, the module may activated its LEDs in two short bursts, then a pause, to indicate it is destined for New York, while another may have LEDs continuously to indicate it is destined for Los Angeles.

Further, Applicant's intent is to encompass the equivalents of all claim elements, and no amendment to any claim the present application should be construed as a disclaimer of any interest in or right to an equivalent of any element or feature of the amended claim.

What we claim is:

1. A system for handling packages comprising:
an electronic module associated with at least one package, said electronic module comprising:
a memory device for storing handling data for said at least one package;
a first transceiver; and
a signaling device operatively coupled to said first transceiver; and
at least one control station comprising a second transceiver for wirelessly communicating with said first transceiver to direct said handling of said at least one package.

2. The system according to claim 1, wherein said electronic module is removably attached to said at least one package.

3. The system according to claim 1, further comprising:
a container for housing said at least one package,
wherein said electronic module is removably attached to said container.

4. The system according to claim 1, wherein said second transceiver transmits a signal to said first transceiver which causes said electronic module to activate said signaling device.

5. The system according to claim 1, further comprising:
a central controller for coordinating an operation of said system.

6. The system according to claim 1, wherein said at least one control station comprises a portable control station.

7. The system according to claim 1, wherein said control station is removably mounted to a delivery vehicle.

8. The system according to claim 1, wherein said control station comprises an input device for at least one of programming and reprogramming said electronic module.

9. The system according to claim 1, wherein said electronic module further comprises a display device and an activating device for activating said display device.

10. The system according to claim 9, wherein said display device comprises at least one of a numeric display and an alphanumeric display.

11. The system according to claim 1, wherein said signaling device comprises one of a light emitting device and an audible signal generator.

12. The system according to claim 1, wherein a conveyor system is automatically reconfigured based on information transmitted from said electronic module.

13. The system according to claim 1, wherein said at least one control station comprises a plurality of control stations.

14. The system according to claim 1, wherein said handling comprises at least one of a sorting operation and a shipping operation for said package, and
wherein said handling data comprises at least one of sorting data and shipping data.

15. A shipping container for use in a system for handling packages, comprising:
a housing for receiving a package; and
an electronic module affixed to said housing, said electronic module comprising a memory device for storing handling data, a transceiver, and a signaling device operatively coupled to said first transceiver.

16. A method for handling packages comprising:
using an electronic module to store handling data pertaining to at least one package; and
wirelessly communicating with said electronic module in order to direct said handling of said at least one package.

17. The method according to claim 16, wherein said wirelessly communicating comprises wirelessly communicating between said electronic module and at least one control station.

18. The method according to claim 17, further comprising:
using a central controller to control said handling of said at least one package.

19. The method according to claim 16, further comprising:
placing said at least one package in a container,
wherein said electronic module is affixed to said container.

20. A signal-bearing media tangibly embodying a program of machine-readable instructions executable by a digital data processor to perform a method for handling packages, said method comprising:
using an electronic module to store handling data pertaining to at least one package; and
wirelessly communicating with said electronic module in order to direct said handling of said at least one package.
